(19) United States
(12) Patent Application Publication
(10) Pub. No.: US 2026/0031527 A1
(43) Pub. Date: Jan. 29, 2026

(54) SATELLITE ANTENNA WITH DUAL-BAND FREQUENCY SWITCHING FUNCTION

(71) Applicant: KNS INC., Daejeon (KR)

(72) Inventors: Byeong Wook JIN, Daejeon (KR); Gil Sang RYU, Daejeon (KR); Young Sun KIM, Daejeon (KR)

(21) Appl. No.: 19/257,139

(22) Filed: Jul. 1, 2025

(30) Foreign Application Priority Data
Jul. 23, 2024 (KR) 10-2024-0097321

(51) Int. Cl. H01Q 1/28; H01Q 3/24; H04B 17/309; H04B 17/391

(52) U.S. Cl. CPC H01Q 1/288; H01Q 3/24; H04B 17/309; H04B 17/391

(57) ABSTRACT

A dual-band satellite antenna having a frequency switching function is described. One aspect of an embodiment relates to a dual-band satellite antenna having a frequency switching function, where the satellite antenna includes: an antenna unit for receiving a satellite signal; a first frequency processing unit configured to process a Ka band frequency for the satellite signal; a second frequency processing unit configured to process a Ku band frequency for the satellite signal; and a switching unit configured to select either the first frequency processing unit or the second frequency processing unit.

### CROSS-REFERENCE TO RELATED APPLICATIONS

This application claims the benefit of Korean Patent Application No. 10-2024-0097321, filed with the Korean Intellectual Property Office on Jul. 23, 2024, the disclosure of which is incorporated herein by reference in its entirety.

### BACKGROUND

### 1. Technical Field

The invention relates to a satellite antenna, more particularly to a satellite antenna having a Ka band-Ku band frequency switching function.

### 2. Description of the Related Art

Generally, satellite communication refers to communication or broadcasting based on a satellite that has been launched to a certain altitude above the earth. Satellite communication can provide various high-quality services, advantageously allowing communication for islands and remote regions and between moving entities, and satellite broadcasting can resolve the problem of poor reception in remote mountainous regions or inner-city regions. A satellite communication system may be divided into space components, which are related to the satellite, ground components, such as earth stations and control stations installed on the ground, and signal components, which are related to methods of transmitting or processing signals, i.e., radio waves.

A satellite communication antenna system for marine use is installed with both an X band antenna and a Ku band antenna, thus requiring a large installation space and high installation costs. Although a dual-band antenna has been developed to address these problems, the conventional dual band (Ka band/Ku band) antenna requires an actual hardware replacement for Ka band-Ku band frequency switching. Such hardware replacement, which may take about 15 minutes on a ship, may pose safety concerns.

### SUMMARY OF THE INVENTION

An aspect of the invention, which was conceived to resolve the problem described above, is to provide a satellite antenna having a dual-band frequency switching function that allows easy switching without a hardware replacement.

Other objectives of the invention will be more clearly understood from the embodiments set forth below.

One aspect of the invention provides a dual-band satellite antenna having a frequency switching function, where the satellite antenna includes: an antenna unit for receiving a satellite signal; a first frequency processing unit configured to process a Ka band frequency for the satellite signal; a second frequency processing unit configured to process a Ku band frequency for the satellite signal; and a switching unit configured to select either the first frequency processing unit or the second frequency processing unit.

Here, the satellite antenna can further include: a communication unit for receiving a control signal from a remote location; and a control unit configured to control the switching unit according to the control signal.

Also, once a switching is processed, the control unit can provide a comparison result between the signals processed by the respective frequency processing units before and after the switching as a result of the control signal.

Also, the control unit can control the switching unit in accordance with a manipulation made on a switching manipulation unit provided on the exterior of the main body.

Also, the control unit can analyze a signal processed by the frequency processing unit currently in use and, if it is determined as a result of the analysis that a change is necessary, can automatically control the switching unit.

Also, the control unit can additionally analyze a signal after the automatic control to determine whether or not another change is to be performed.

Also, the satellite antenna can further include a memory for storing a switching history, where the control unit can determine an analysis time point and whether or not to perform automatic control based on the switching history.

According to another aspect of the invention, the antenna unit can further include: a directional antenna unit for receiving a satellite signal; and an omnidirectional antenna unit for receiving a surrounding signal that includes the satellite signal.

Here, the antenna unit can further include: a noise generator unit configured to generate an ambient noise signal by subtracting the satellite signal received at the directional antenna unit from the surrounding signal including the satellite signal received at the omnidirectional antenna unit; and a noise remover unit configured to generate a noiseless satellite signal by subtracting the ambient noise signal from the satellite signal received at the directional antenna unit.

A satellite antenna according to an embodiment of the invention makes it possible to change the frequency band by way of a control made from a remote location without having to make direct hardware replacements, to thus provide greater convenience in management and prevent the occurrence of safety hazards which may otherwise accompany the manual replacements.

Other aspects, features, and advantages besides those set forth above will be made more apparent from the drawings, claims, and descriptions of the invention set forth below.

### BRIEF DESCRIPTION OF THE DRAWINGS

FIG. 1 is a functional block diagram illustrating the composition of a satellite antenna having a dual-band frequency switching function according to an embodiment of the invention.

FIG. 2 is a flowchart illustrating a process for changing the frequency band performed at a satellite antenna according to an embodiment of the invention.

FIG. 3 is a flowchart illustrating a process for changing the frequency band in a typical hardware replacement type system.

FIG. 4 is a flowchart illustrating a process for automatically changing the frequency band according to an embodiment of the invention.

### DETAILED DESCRIPTION OF THE INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed by the present invention.

When a component is mentioned as being “coupled” or “connected” to another component, this may mean that the component is directly coupled or connected to the other component or may mean that they are coupled or connected with still another component in-between. On the other hand, if a component is mentioned as being “directly coupled” or “directly connected” to another component, this should be understood as meaning that there are no other components between the mentioned components.

While such terms as “first” and “second,” etc., can be used to describe various components, such components are not to be limited by the above terms. The above terms are used only to distinguish one component from another. For example, terms such as a first threshold value, a second threshold value, etc., used below may refer to threshold values that are pre-designated to be substantially different or partially the same. Since there is a risk of confusion arising if these concepts were to be referred to by the same term “threshold value”, the ordinal numbers first, second, etc., are added to more easily differentiate the concepts.

The terms used in the present specification are merely used to describe particular embodiments and are not intended to limit the present invention. An expression used in the singular encompasses the expression of the plural, unless it has a clearly different meaning in the context. In the present specification, it is to be understood that terms such as “including” or “having,” etc., are intended to indicate the existence of the features, numbers, steps, actions, components, parts, or combinations thereof disclosed in the specification and are not intended to preclude the possibility that one or more other features, numbers, steps, actions, components, parts, or combinations thereof may exist or may be added.

Also, the components of an embodiment described with reference to each drawing are not necessarily applied exclusively to the corresponding embodiment and can be implemented so as to be included in another embodiment as long as the spirit of the invention is maintained. Moreover, it should be appreciated that multiple embodiments can be implemented as a single combined embodiment, even though it is not expressly stated as such.

In describing the appended drawings, the same components are assigned the same or related reference numerals regardless of the figure number, and redundant explanations are omitted. In the description of the present invention, certain detailed explanations of the related art are omitted if it is deemed that they may unnecessarily obscure the essence of the invention.

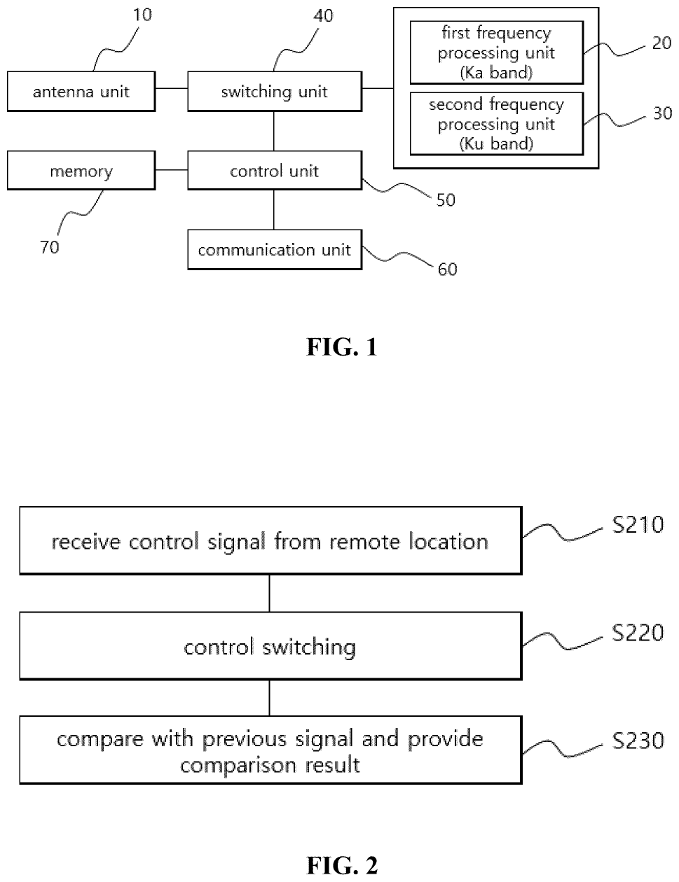

FIG. 1 is a functional block diagram illustrating the composition of a satellite antenna having a dual-band frequency switching function according to an embodiment of the invention.

Referring to FIG. 1, a satellite antenna based on this embodiment may include an antenna unit 10, a first frequency processing unit 20, a second frequency processing unit 30, a switching unit 40, a control unit 50, a communication unit 60, and a memory 70.

Providing an overall description of a satellite antenna system, the satellite antenna system may track a satellite through a signal recognition and stabilization function, and the antenna control unit may transmit information associated with the navigation of a ship and satellite inertia to the satellite antenna. The user may use a modem to receive emergency and aid requests and broadcasts or access telephone or Internet communications.

The satellite antenna system may include an upper radome, a lower radome, a pedestal control unit (PCU), an inertial measurement unit (IMU), a multi-RF unit (MRU), and a pedestal. The upper radome may protect the equipment from the ocean environment, and the lower radome may protect the equipment from the ocean environment and be secured to the pedestal and the body of the ship. The antenna may be a dish-shaped parabolic antenna and may serve to collect or transmit satellite signals, the PCU may be a device that searches and tracks the antenna, the IMU may check inertia information, the MRU may be a device that processes analog and digital signals received from the satellite, and the pedestal may be a mechanical structure that supports the antenna and is movable in a desired direction along each axis.

Referring again to the drawings, the antenna unit 10 may be for receiving satellite signals. As the specifics of the antenna unit 10 should be obvious to the skilled person, they are not described here in further detail.

The first frequency processing unit 20 may be for processing signals of the Ka frequency band, while the second frequency processing unit 30 may be for processing signals of the Ku frequency band.

The Ka band refers to the frequency band of 26.5 GHz to 40 GHz designated by the Institute of Electrical and Electronics Engineers (IEEE) in the United States. The Ka band represents a band that is “above the K band (K-above).” The Ka band entails a short wavelength of 1.11 cm˜7.5 mm, so that rainy and cloudy weather may lead to high attenuation. With the advent of 5^{th} generation (5G) mobile communication, the European Conference of Postal and Telecommunications Administrations (CEPT) designated the 24.25˜27.5 GHz band of the Ka band for IMT-2020 in Europe, and countries such as South Korea, Japan, the United States, etc., have designated the 28 GHz band for IMT-2020 use. In South Korea, the 26.5˜28.9 GHz band was set up for auction in 2018 for 5G mobile communication use to mobile communication providers.

The Ku band refers to the frequency band of 12 GHz to 18 GHz designated by the Institute of Electrical and Electronics Engineers (IEEE) in the United States. The Ku band is mainly used for downlink transmissions in satellite communications. Also, the International Telecommunications Union (ITU) designated the use of the Ku band by region to allow a more efficient use of the Ku band in a manner suited to the characteristics of each region. In Europe, a portion of the Ku band is used for radars that measure vehicle speeds. The name of the Ku band is an abbreviation of “K-under” (originally, Kurtz-unten), representing a frequency band under the K band (20˜40 GHZ). Globally, the Ku band is largely used for satellite communications and thus is in a saturated state. In certain regions, satellite communication applications are moving towards the Ka band.

Thus, there is a need for a satellite antenna that can utilize both the Ka band and the Ku band. Whereas the existing art uses a system involving hardware replacement, an embodiment of the invention provides a frequency processing unit for each of the two bands.

The switching unit 40 may select either the first frequency processing unit or the second frequency processing unit 30 and process signals of the corresponding band. The switching unit 40 can be controlled by the control unit 50, and the control unit 50 may control the switching in accordance with control signals received via the communication unit 60 from a management system. In other words, the administrator is able to change the frequency the band of the satellite antenna from a remote location. The communication unit 60 may be for communicating with a management system that is connected in a wired or wireless manner. As the communication method should be obvious to the skilled person, it is not described here in further detail.

The memory 70 may store various data needed for the control unit 50 to function. Switching history, for example, can be kept in the memory 70, as will be described later on, where the switching history can be utilized in automatic changing, etc.

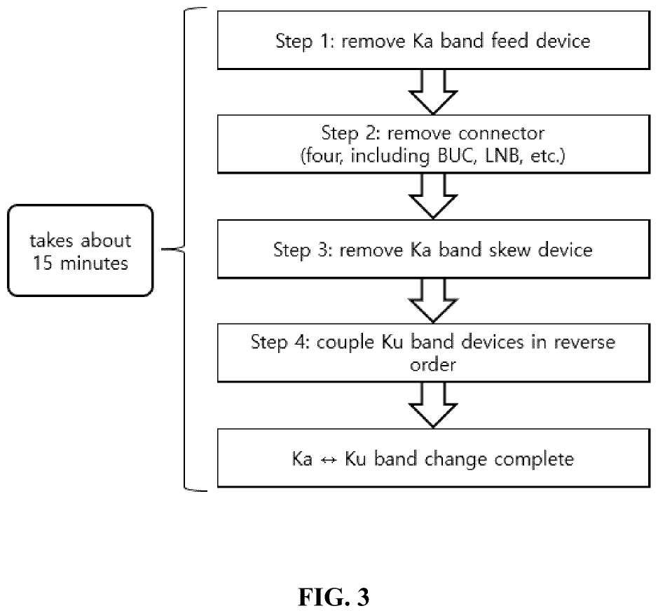

FIG. 2 is a flowchart illustrating a process for changing the frequency band performed at a satellite antenna according to an embodiment of the invention, and FIG. 3 is a flowchart illustrating a process for changing the frequency band in a typical hardware replacement type system.

Referring to FIG. 2, upon receiving a control signal regarding a frequency change from a remote location (for instance, the management system, an administrator terminal, or a separate remote controller, etc.) (S210), the satellite antenna may perform a switching control (S220). For example, if the first frequency processing unit 20, which processes the Ka band, is in operation, then a switch may be performed such that the second frequency processing unit 30, which processes the Ku band, is operated.

According to one example, in order that the administrator may perceive whether or not the change was performed properly, the satellite antenna may compare the signal that was processed before the change with the signal that is being processed after the change and may provide the comparison result as a response to the change command. For example, the satellite antenna may compare the signal of the Ka band that was being processed by the operation of the first frequency processing unit 20 with the signal of the Ku band that is processed by the operation of the second frequency processing unit 30 after the change and may provide the comparison result. Thus, the administrator can check whether or not the change in frequency band was performed properly.

Referring to FIG. 3, which illustrates the processing involved in a hardware replacement type system as a comparison, the hardware equipment related to the feed, connector, and skew for the band before the change must be removed one by one, after which the hardware equipment for the other frequency band must be coupled on again in reverse order. A dual-band antenna that has separate replaceable parts for the satellite frequency processing of different bands for the antenna is referred to as a convertible antenna. Integrated parts are provided separately for the portions converting satellite frequencies to local frequencies, i.e., the antenna, feed horn, LNB, BUC, etc., and the operator must manually replace these parts when a change in band frequency is required.

Thus, whereas the above system requires manual replacements and hence entails labor costs and the risk of safety hazards, this embodiment of the invention can change the frequency band remotely from within a ship, etc. This allows a quicker change and obviates the need for manual replacement, thereby reducing costs and preventing safety hazards.

Also, although it is not illustrated in the drawings, another example can have a manipulation device (for example, a switch, etc.) for the switching change provided on the exterior of the satellite antenna. That is, the control unit 50 may control the switching unit 40 in accordance to a manipulation made on a switching manipulation unit (switch or button, etc.) provided on the exterior of the main body. According to this embodiment, it would be possible to perform a frequency change by manipulating the switch directly, in the event of a communication failure or a problem in the communication unit 60 itself.

The descriptions above focus on a system for changing the frequency band by a control made from a remote location. In another example, the frequency band can also be changed automatically by applying a particular set of criteria at the satellite antenna itself. The following provides a description of such automatic change.

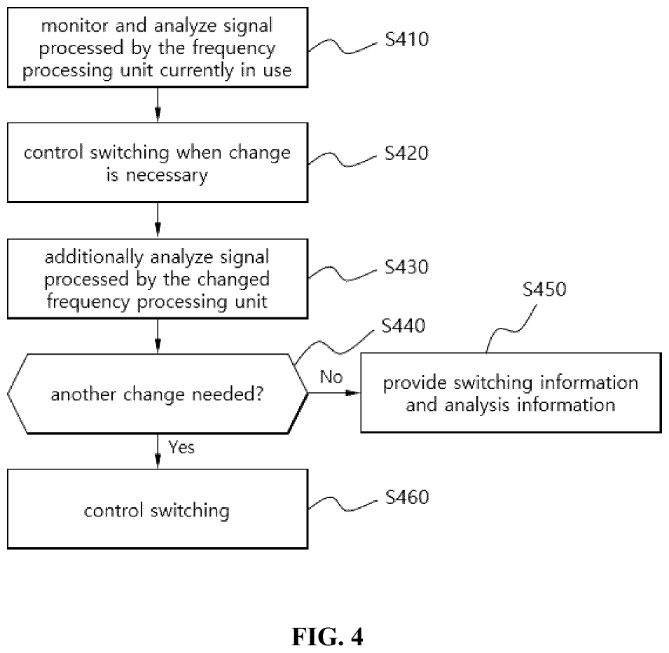

FIG. 4 is a flowchart illustrating a process for automatically changing the frequency band according to an embodiment of the invention.

Referring to FIG. 4, the signal processed by the frequency processing unit currently in use may be monitored and analyzed (S410). For example, it may be monitored whether or not the satellite signal currently detected is being properly received, and if there are no signals received for a certain duration (e.g., 10 seconds, etc.), it may be determined that a change is needed.

If it has been determined that a change is needed, the switching may be controlled to change the frequency band (S420).

The signal processed by the changed frequency processing unit may be analyzed again (S430). For example, it may be analyzed whether or not the signal that is to be received by the corresponding frequency processing unit, such as the satellite signal, etc., is properly being received.

Based on the analysis result regarding whether or not the signal is properly received, it may be determined whether or not another change is needed (S440). Alternatively, the decision of whether or not to change again can be queried to the administrator, where the analysis from S410 and the analysis from S430 may be reported to the administrator.

If it is determined that another change is needed, then the switching may be controlled again (S460), but if it is determined that another change is not needed, then information on how the switching was performed and the analysis results of S410 and S430, etc., may be provided to the administrator (S450).

As described above, the times at which the signals is analyzed and the decision on whether or not to apply automatic control can be determined based on a switching history (the number of switches, the dates (and times) of the switches, the locations at which the switches occurred, etc.) that is stored in the memory 70. For example, if there a history of switching always occurring from the Ka band to the Ku band in a particular region, and if no change control signal is being received while in this corresponding region, then an analysis of the satellite processing signal can be performed to determine whether or not to perform an automatic change. In another example, if there is a history of repeated switching occurring not only within a region but within a particular time slot, the automatic change can also be performed based on the corresponding time.

According to this embodiment, an automatic changing of the frequency band can be performed based on an analysis of the switching history. As the administrator does not need to repeatedly input each change command, the management can be performed more conveniently.

Also, the analysis of the switching history and the automatic change can be performed with greater precision by way of artificial intelligence learning. For example, the relationships between various factors such as the location, time slot, weather, etc., and the switching can be analyzed as accumulated switching history and learned, so that the automatic change may be performed more accurately as desired by the administrator.

In another embodiment of the invention, the antenna unit can further include a directional antenna unit for receiving satellite signals and an omnidirectional antenna for receiving surrounding signals, including the satellite signals.

The directional antenna unit for receiving the satellite signals can be provided to mainly receive the signals of a particular satellite. The directional antenna unit can further include a Cassegrain antenna or a parabolic antenna, for example, to focus on and receive satellite signals that are transmitted from a particular direction.

The omnidirectional antenna unit may not have directionality and can receive signals uniformly in all directions. The omnidirectional antenna unit can include, for example, a coil antenna, a helical antenna, or a dipole antenna. Waves received by the omnidirectional antenna unit can include not only the signals of a particular satellite but also signals transmitted by various satellites as well as the surrounding electromagnetic wave noise.

Also, the antenna unit can further include a noise generator unit, which may generate an ambient noise signal by subtracting the satellite signal received at the directional antenna unit from the surrounding signal received at the omnidirectional antenna unit that includes the satellite signal, and a noise remover unit, which may generate a noiseless satellite signal by subtracting the ambient noise signal from the satellite signal received at the directional antenna unit.

The satellite signal received at the directional antenna unit can include surrounding noise. Therefore, modulating the satellite signal received at the directional antenna unit can result in a reduced signal-to-noise ratio or amplified noise. To avoid these problems, the waves received at the omnidirectional antenna unit can be subtracted to remove noise and leave only the satellite signal limited to a desired satellite, so that the satellite signal modulation performance may be improved.

While the foregoing provides a description with reference to an embodiment of the present invention, it should be appreciated that a person having ordinary skill in the relevant field of art would be able to make various modifications and alterations to the present invention without departing from the spirit and scope of the present invention set forth in the scope of claims below.

What is claimed is:

1. A dual-band satellite antenna having a frequency switching function, the satellite antenna comprising:
an antenna unit for receiving a satellite signal;
a first frequency processing unit configured to process a Ka band frequency for the satellite signal;
a second frequency processing unit configured to process a Ku band frequency for the satellite signal; and
a switching unit configured to select either the first frequency processing unit or the second frequency processing unit.

2. The dual-band satellite antenna having a frequency switching function of claim 1, further comprising:
a communication unit for receiving a control signal from a remote location; and
a control unit configured to control the switching unit according to the control signal.

3. The dual-band satellite antenna having a frequency switching function of claim 1, wherein the control unit, once a switching is processed, provides a comparison result between signals processed by the respective frequency processing units before and after the switching as a result of the control signal.

4. The dual-band satellite antenna having a frequency switching function of claim 2, wherein the control unit controls the switching unit in accordance with a manipulation made on a switching manipulation unit provided on an exterior of a main body.

5. The dual-band satellite antenna having a frequency switching function of claim 3, wherein the control unit analyzes a signal processed by a frequency processing unit currently in use and, if it is determined as a result of analysis that a change is necessary, automatically controls the switching unit.

6. The dual-band satellite antenna having a frequency switching function of claim 5, wherein the control unit additionally analyzes a signal after the automatic control to determine whether or not another change is to be performed.

7. The dual-band satellite antenna having a frequency switching function of claim 6, further comprising a memory for storing a switching history,
wherein the control unit determines an analysis time point and whether or not to perform automatic control based on the switching history.

8. The dual-band satellite antenna having a frequency switching function of claim 1, wherein the antenna unit further comprises:
a directional antenna unit for receiving a satellite signal; and
an omnidirectional antenna unit for receiving a surrounding signal, the surrounding signal including the satellite signal.

9. The dual-band satellite antenna having a frequency switching function of claim 8, wherein the antenna unit further comprises:
a noise generator unit configured to generate an ambient noise signal by subtracting the satellite signal received at the directional antenna unit from the surrounding signal including the satellite signal received at the omnidirectional antenna unit; and
a noise remover unit configured to generate a noiseless satellite signal by subtracting the ambient noise signal from the satellite signal received at the directional antenna unit.
